(19) United States
(12) Patent Application Publication
(10) Pub. No.: US 2022/0356424 A1
(43) Pub. Date: Nov. 10, 2022

(54) NATURAL FINING AGENT FOR BEVERAGES

(71) Applicant: Kerry Group Services International Limited, Co. Kerry (IE)

(72) Inventors: Shekhar Umakantrao Kadam, Co.Kildare (IE); Jacques Georis, Couthuin (BE); Eoin Lalor, Co. Kildare (IE); Jonathan Doyle, Co. Cork (IE); Daragh Cuskelly, Co. Kildare (IE)

(73) Assignee: Kerry Group Services International Limited, Co. Kerry (IE)

(21) Appl. No.: 17/707,143

(22) Filed: Mar. 29, 2022

Related U.S. Application Data
(60) Provisional application No. 63/186,417, filed on May 10, 2021.

(51) Int. Cl. C12H 1/056; C12H 1/14

(52) U.S. Cl. CPC C12H 1/0424; C12H 1/14

(57) ABSTRACT

A fining formulation/agent contains pectin, particularly, low-methoxy pectin, and yeast extract. A method of fining beverages, particularly beers and wines, including adding the fining formulation/agent to a beverage, particularly during a fermented beverage manufacturing process.

### FIELD OF THE DISCLOSURE

The present application relates to improved fining agents, which are obtained from natural and non-meat or animal products, that can be useful to sediment yeast, and separate and filter biological and chemical haze causing agents for beverage manufacturing processes, a method of fining beverages using the natural fining agents, and beverages produced by the disclosed method. The natural fining agents are particularly useful in fining beverages produced by fermentation, such as beers and wines.

### BACKGROUND OF THE DISCLOSURE

Fermented cereal, legume or fruit based beverages such as beer, wine, cider etc. are often cloudy or hazy from raw material processing until filtration step. The haze in fermented beverages can be due to the presence of protein and polyphenols like tannin molecules, along with yeast cells. The problem is particularly relevant to the brewing and wine manufacturing industries. Often, a process of clarifying, or fining, beverages is needed to remove unwanted material from beverages and to produce beverages with improved appearance, aroma, and/or taste.

Fining agents are usually added at or near the completion of the processing of brewing wine, beer, and various nonalcoholic juice beverages. They are used to remove yeast and biological and chemical haze causing compounds, either to improve clarity or adjust flavor or aroma. The removed compounds may be yeast, sulfides, proteins, polyphenols, benzenoids, copper ions, etc.

For example, a fermented beer including non-flocculent yeast is generally moved into a maturation vessel in which maturation takes place. After maturation the beer is usually filtered before being packaged into bottles, cans, or kegs.

A commonly used yeast flocculating agent or fining agent in the brewing industry is isinglass. Isinglass is a collagen product obtained from the swim bladder of fish. Although isinglass is an effective fining agent and yeast flocculating agent, vegetarian and vegan consumers do not consider products containing isinglass suitable for their dietary requirements. Auxiliary finings agents such as silicates or polysaccharides may be used together with isinglass.

Fining agents such as Silica based fining agents and carrageenan provide variable results according to the industry and may have drawbacks such as poor compaction and contamination of yeast residues.

WO 2006032088A2 discloses a fining formulation comprising a pectin and a donor of sulphur dioxide.

WO 95/04130A1 discloses a method of removing excess yeast, high molecular weight proteins, and other suspended matter from fermented beer by bringing the beer into contact with magnetic particles.

WO 97/06274 discloses a composition derivable from yeast cells comprising proteinaceous material having an isoelectric point in the range 3 to 6. The composition is prepared by a selective pH extraction from yeast cells, and is useful as a flocculant in a variety of industrial applications, and in particular in the clarification of beer.

U.S. Pre-Grant Publication No. 2016/0053212 A1 discloses a fining agent which may be prepared by subjecting hops to organic solvent (such as acetone or alcohol) extraction, aqueous solvent extraction, or mixed solvent extraction.

The existing fining agents have been found to have the following disadvantages and setbacks:
1) Use of isinglass (fish collagen)—animal origin, possible allergen concerns and high cost-in-use;
2) Use of silica sol and PVPP (Polyvinylpolypyrrolidone)—chemical nature and high cost-in-use;
3) Pectins—lower fining efficiency and higher sediment volumes (not process-friendly);
4) Chitosan—lower fining efficiency, animal origin and higher cost-in-use;
5) Proteins from plant sources—lower fining efficiency and higher cost-in-use.

### SUMMARY OF THE DISCLOSURE

An object of the present disclosure is to develop an alternative to animal (such as isinglass) and chemical (such as silica sol) based fining agents to sediment yeast, and separate and filter biological and chemical haze causing agents for beverage manufacturing processes. The alternative fining agents of the present disclosure are economical, easy to produce, and/or overcome these disadvantages of the conventional fining and flocculating agents.

The present inventors conducted extensive research and discovered that a formulation containing a pectin and a yeast extract is efficient in fining beverages, particularly beers, wines, ciders, etc. Furthermore, this non-animal and non-chemically sourced fining agent containing pectin and yeast extract in combination was found to offer similar or better fining efficiency compared to isinglass and silica sol. The fining formulation/agent according to the present disclosure is suitable for vegetarians and free of allergens and harsh chemicals like silica sol. The fining formulation/agent according to the present disclosure can also provide a lower cost-in-use compared to existing technologies. The fining formulation/agent according to the present application can also provide compact sediment and easier separation of unwanted materials in beverages.

The present disclosure relates to a fining formulation/agent comprising a pectin and a yeast extract for fining (clarifying) beverages, a method of fining beverages using the fining formulation/agent, and beverages produced by the disclosed method.

In one embodiment, the present disclosure is directed to a method of fining a beverage, which includes adding to the beverage a pectin and a yeast extract.

In one aspect, the total combined amount of pectin and yeast extract is 5-600 ppm, preferably 25-500 ppm, of the total beverage volume at the time of addition.

In one aspect, the pectin is a low-methoxy pectin. For example, the pectin can have a DE of 5%-50%, 10% to 45%, 15 to 40%, or preferably 15% to 35%.

In one aspect, the fining agent includes 5% to 95% by weight of pectin and 5% to 95% by weight of yeast extract, preferably 10% to 90% by weight of pectin and 10% to 90% by weight of yeast extract. In other aspects, the weight ratio can be 15:85 to 85:15, or 20:80 to 80:20, or 25:75 to 75:25, or 30:70 to 70:30, or 35:65 to 65:35, or 40:60 to 60:40, or 45:55 to 55:45.

In one aspect, the yeast extract is cell wall material, carbohydrate profile, and/or protein rich extracts of a yeast. Examples of the yeast extract include but are not limited to spray-dried yeast extract, dried autolysed yeast powder produced from a selected strain of bakers' yeast, dried yeast cell wall, dried baker's yeast cell walls rich in mannoproteins, a spray-dried extract from baker's yeast made from yeast grown specifically for cell nutrition purposes. The yeast extract can be used alone or in combination with another yeast extract. An example of the yeast includes Saccharomyces cerevisiae. The yeast extract contains protein in an amount of 10% to 90% by weight of the yeast extract, preferably 20% to 80%, or 30% to 70% by weight.

In some aspects, yeast extract could be derived from different Saccharomyces spp., Candida spp. Rhodotorula spp., Torulopsis spp., Cryptococcus spp., Leucosporidium spp., Trichosporon spp., and Schizosaccharomyces spp.

In one aspect, the pectin and yeast extract can be dissolved separately in deaerated water, beer or other medium and added in individually in two separate steps at the beginning of or during maturation in a beverage manufacturing process, such as a brewing process. Alternatively, the pectin and yeast extract can be formulated into one powder form, dissolved in deaerated water, and added in a single step at the beginning of or during maturation in a beverage manufacturing process, such as a brewing process.

In another embodiment, the present disclosure is directed to a fining agent as defined above.

In one aspect, the fining agent defined above is contained in a sealed (and optionally sterile) container or package for individual sale or delivery to a beverage maker.

In one aspect, the fining agent is in powder or other forms such as an emulsion, a liquid or a paste, and the powdered fining agent or the fining agent in other forms can be contained in the sealed container or package as defined above.

In another embodiment, the present disclosure is directed to a beverage containing the fining agent as defined above.

In one aspect, the beverage is a beverage in an intermediate processing stage, such as a combination of the fining agent with beer in the maturation phase.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 shows fining efficiency of different grades of pectin.

FIG. 2 shows beer fining efficiency of different ingredients.

FIG. 3 shows fining efficiency of different grades of yeast extracts.

FIG. 4 shows effect of combination of pectin and yeast extract on beer fining efficiency over 24 hours.

FIG. 5 shows effect of combination of pectin and yeast extract on beer fining efficiency over 96 hours.

FIG. 6 shows effect of fining agent on lager base beer.

FIG. 7 shows effect of fining agent on red ale base beer.

FIG. 8 shows effect of fining agent on IPA base beer.

FIG. 9 shows finning trials using 100 ml sedimentation cones.

FIG. 10 shows effect of calcium on beer fining efficiency.

FIG. 11 shows effect of pH on beer fining efficiency.

FIG. 12 shows beer fining efficiency at pilot scale of 3 hL brewery.

### DETAILED DESCRIPTION OF THE DISCLOSURE

The details of embodiments of the presently disclosed subject matter are set forth in the accompanying description below. Other features, objects, and advantages of the presently disclosed subject matter will be apparent from the specification, figures, and claims. All publications, patent applications, patents, and other references noted herein are incorporated by reference in their entirety.

The present disclosure relates to a fining formulation/agent containing a pectin and a yeast extract for fining beverages. In some aspects, the fining formulation consists of a pectin and a yeast extract, optionally in powder form. The present disclosure also relates to a method of fining beverages using the fining formulation, as well as beverages prepared by the disclosed method.

Beverages suitable for the present application include alcoholic beverages such as beers and wines, fermented beverages, and fruit beverages, etc.

Pectins are polysaccharides having gelling properties. Highest concentrations of pectin are found in the middle lamella of cell wall, with a gradual decrease as moving through the primary wall toward the plasma membrane. Pectins are most abundant in fruits and vegetables.

A pectin molecule is basically a chain of galacturonic acid units. The regular structure is interrupted by the presence of a methylpentose, L-rhamnose, which causes deviations called “pectic elbows”. The L-rhamnose is linked by carbons 1 and 2. A certain proportion of these galacturonic acids are in the methyl ester form. The percentage of the galacturonic acids that are esterified is called the degree of esterification (DE) or degree of methoxylation (DM). High methoxy (HM) pectins are defined as those with a DE of 50% or above, while low methoxy (LM) pectins have a DE of less than 50%. The degree of amidation (DA) is defined as the percentage of carboxyl groups that are in the amide form. Amidated pectins have a DE of usually between 20% and 45% and a DA of usually between 5% and 25%.

Pectins suitable for the present application are not particularly limited. Preferably low-methoxy pectins having a DE of less than 50% are used in the present application. The low-methoxy pectins may have a DE of between 5% and less than 50%, preferably between 10% and 45%, more preferably between 15% and 35%. The low-methoxy pectins may have a DA of between 5% and 25%, preferably between 10% and 25%, more preferably between 15% and 20%.

The pectins used in the formulations and methods of the present disclosure may be commercially available or prepared by conventional processes of de-esterification or amidation of naturally occurring pectins, e.g. fruit pectins such as apple, citrus, quince, plums, gooseberries, oranges or pectin from other sources with similar structure or attributes.

Yeast extracts are conventionally used as food additives or flavorings, or as nutrients for bacterial culture media.

Yeast extracts or other type of extracts suitable for the present application include extracts rich in cell wall material and mannoproteins. Examples of the yeast extract include but are not limited to spray-dried yeast extract, dried autolysed yeast powder produced from a selected strain of bakers' yeast, dried yeast cell wall, dried baker's yeast cell walls rich in mannoproteins, a spray-dried extract from baker's yeast made from yeast grown specifically for cell nutrition purposes. The yeast extract can be used alone or in combination with another yeast extract. An example of the yeast includes Saccharomyces cerevisiae. The yeast extract contains protein in an amount of 10% to 90% by weight of the yeast extract, preferably 20% to 80%, or 30% to 70% by weight.

A fining formulation/agent according to the present disclosure may contain about 5-99% (w/w) pectin, or 10-90% (w/w), 15-85% (w/w), 20-80% (w/w), 25-75% (w/w), 30-70% (w/w), 35-65% (w/w), or 40-60% (w/w) of pectin, and about 5-95% (w/w) yeast extract, or about 10-90% (w/w), 15-85% (w/w), 20-80% (w/w), 25-75% (w/w), 30-70% (w/w), 35-65% (w/w), or 40-60% (w/w) of yeast extract. The amounts refer to the composition of a solid formulation, i.e. dry weight.

In some aspects, the fining formulation is provided in the form of a dried powder, which may be sealed in a package or container for sale, as noted above. In some aspects, the fining formulation in the form of a dried powder consists of the pectin and the yeast extract with water as an impurity (preferably less than 1% by weight).

The fining formulation/agent may also be provided as an aqueous solution. A preferred fining formulation in an aqueous solution with deaerated water includes 0.1% to 20% (w/v) of pectin, or 0.5% to 19% (w/v), 1% to 18% (w/v), 5% to 15% (w/v),or 8% to 12% (w/v) of pectin, and 0.1% to 20% (w/v) yeast extract, or 0.5% to 19% (w/v), 1% to 18% (w/v), 5% to 15% (w/v),or 8% to 12% (w/v) of yeast extract.

A method of adding the fining agent of the present disclosure is not particularly limited, as the use of fining agents in general is conventionally known, particularly in the beer and wine industries. For example, according to the present disclosure, a method of fining a beverage may include a step of adding the fining formulation/agent of the present disclosure to a beverage during the beverage manufacturing process, such as after fermentation and/or at the beginning or during maturation of the beverage, as carried out in a standard fining process. The fining agent accelerates the clarification of beverages, such as beer and wine, once the fermentation process is complete and when the beverage is in a maturation process. The beverages can be filtered after maturation by filtration, such as with use of conventional filter aids and/or membrane filtration, including cross-flow filtration. The fining process ideally produces compact flocs, which facilitates more efficient filtration and easier separation.

Pectin and yeast extract can be dissolved separately in deaerated water and added in two separate steps at the beginning of or during maturation in a beverage manufacturing process, such as a brewing process. They can be added separately sequentially or separately consecutively, in any order. Alternatively, pectin and yeast extract can be formulated into one powder form, dissolved in deaerated water and added in a single step at the beginning of or during maturation in a beverage manufacturing process, such as a brewing process. Pectin and yeast extract can be added after fermentation and cooling. In other words, the maturation process can be warm or cold. It can also include general beverage processes including conditioning, maturation, flocculation sedimentation, decanting etc. parameters where yeast or haze causing complexes are separated based on beverage type and style.

The fining formulation/agent of the present disclosure can be added to a tank which contains a fermented beverage such as a beer or a wine. Alternatively, the fining formulation/agent of the present disclosure can be added as a liquid stream into a beverage stream such as a beer or wine stream. The fining formulation/agent may be dispersed in the beverage by good agitation, such as by a recirculation pump, a homogenizer, or other proper mechanical devices.

The concentration of pectin used is at least 10 ppm (parts per million), preferably at least 590 ppm, of final concentration of the fluid volume of the beverage. The concentration of yeast extract used is at least 10 ppm (parts per million), preferably at least 590 ppm, of final concentration of the fluid volume of the beverage. The total concentration of pectin and yeast extract used is between 10 and 600 ppm (parts per million), that is, the amount of pectin and yeast extract in the final beverage is 0.001 to 0.06% (w/v). Preferably, the total combined concentration of pectin and yeast extract used is 25, 50, 100, 150, 200, 300, 400, 500, 600 ppm, of final concentration of the fluid volume of the beverage.

Preferably the fining method of the present disclosure comprises making an 0.1% to 20% aqueous solution of pectin, and an 0.1% to 20% aqueous solution of yeast extract, adding an amount of the solutions to a post separation beverage such as beer or wine to obtain a concentration of pectin and yeast extract of about 10 to 600 ppm, preferably 50 to 250 ppm, processing beverage (such as beer or wine) fining for 12 to 96 hours and then filtering. A good fining agent will have a comparable filterability rate to isinglass.

Yeast extracts, due to its proteinaceous nature, form large size complexes which sediment at a faster rate resulting better fining efficiency. It was found that, when both of pectin and yeast extract are used in combination as a fining agent, they provide synergy of action and achieve better sedimentation and a clearer beverage, such as beer, compared to when they are added in an individual capacity.

Based on the initial concentration of yeast cells, proteins, polyphenols, metal ions, and carbohydrates in the beverage, some additives which are able to increase finings effect (rates of clarification, and reduction in residual fining components in the final product) may be added to the fining formulation or during the fining process. For example, tannic acid, basic proteins, or hop extracts may be used.

The present disclosure has major utility, for example, in fining alcoholic beverages, particularly those that are fermented such as beers and wines.

The term “finings agent” refers to any material that is used to clear a ferment (clarification) by promoting aggregation and compact settling (compact/coherent settling).

The term “fining process” refers to any process that uses a fining agent to clear a ferment (clarification) by promoting aggregation and compact settling (compact/coherent settling).

Clarification (or clarifying) refers to the clearing of a ferment which is judged, by observation or measurement, by one or several or all of the criteria: an increase in visual transparency, an increase in light transmittance, a decrease in turbidity or light scattering, a reduction in particle number, an improvement in the filterability of the clarified beverage through a membrane of restricted porosity.

Description of an Exemplary Fining Process

In an exemplary fining process, a dry fining agent (mixture) comprising a mixture containing 5-90% (w/w) pectins, and about 10-95% (w/w) yeast extract, is prepared by dry blending. The mixture is then slowly added to deaerated water at room temperature with preferably continuous mixing until the solids are completely solubilized. This process can be enhanced using a recirculation pump, a homogenizer, and/or other proper mechanical devices. The pectin concentration of the fining solution can be as high as 90-95% (w/v) depending on the type and nature of the pectin and the temperature. The yeast extract concentration of the fining solution can be as high as 90-95% (w/v) depending on the temperature. The dry fining mixture may be stored for several months at 1-4° C. in an airtight container. The liquid fining preparation is stable microbiologically and in fining activity for several weeks.

The fining agent is mixed with beer usually after centrifuging to reduce the yeast contents, to obtain a combined concentration of about 10-600 ppm of pectin and yeast extract, preferably 50-250 ppm for most tested beers. Some additives such as tannic acid, basic proteins, or hop extracts may be added at this time to increase fining effect. The effect of these additives will depend to some degree on the nature of the beer. The beer should be stored, preferably at about 0-2° C. for at least 12 hrs to 72 hrs before final filtration.

Effective fining activity is defined herein as fining activity comparable to the fining performance of isinglass in beer.

Having now fully described the disclosure, it will be appreciated by those skilled in the art that the same can be performed within a wide range of equivalent parameters, concentrations, and conditions without departing from the spirit and scope of the disclosure and without undue experimentation. While this disclosure has been described in connection with specific embodiments thereof, it will be understood that it is capable of further modifications. This application is intended to cover any variations, uses, or adaptations of the disclosure following, in general, the principles of the disclosure and including such departures from the present disclosure as come within known or customary practice within the art to which the disclosure pertains and may be applied to the essential features hereinbefore set forth.

The present disclosure will now be described by way of reference only to the following non-limiting examples and drawings.

### EXAMPLES

### Example 1

Effect of Different Ingredients on Fining

1A. Different Grades of Pectin Compared with Isinglass and Silica Sol.

Beer preparation: Wort was prepared using 100% malt extract with original gravity (OG) of 1.045. Prepared wort was boiled for 45 min with 0.01% grist w/w hop pellets added at the start of boil. Carrageenan was added 5 min before the end of boiling. After the wort was cooled, Safale K-97 yeast was added at 250 g/HL. Fermentation was carried out for 5 days. Green beer was decanted and stored in a cold temperature below 4° C. for finings dosage.

Finings Dosing: Different grades of pectins including HM pectin (DE of 68-76%), LM pectin (DE of 27-32%) and commercial brewing grade pectin were compared with isinglass and silica sol for fining efficiency. For dosing into green beer, finings were made as a stock solution of 2-5% by being dissolved in water. Finings were mixed in water vigorously using a magnetic stirrer until dissolved completely. Green beer (250 ml) was poured into clear bottles, the stock solution (volume based on final desired concentration in green beer) of finings was dosed into the green beer. Bottles were shaken to allow for uniform mixing and stored at a temperature of 0-4° C. for from 24 up to 96 hours as per requirement of analysis.

Haze measurement: A sample was poured into a sample cuvette by pipetting 10 ml of the sample from the top of each beer bottle. Haze was measured using Hach Turbiditymeter 2100AN IS.

Finings Tested: In this example, the HM pectin and the LM Pectin were added to a beer at a dose rate of 5, 25, 50 and 100 ppm and the standard pectin was added at a dose rate of 100 and 400 ppm. Fining efficiency was compared with a control with no fining agent, isinglass at 50 ppm and silica sol at 1000 ppm.

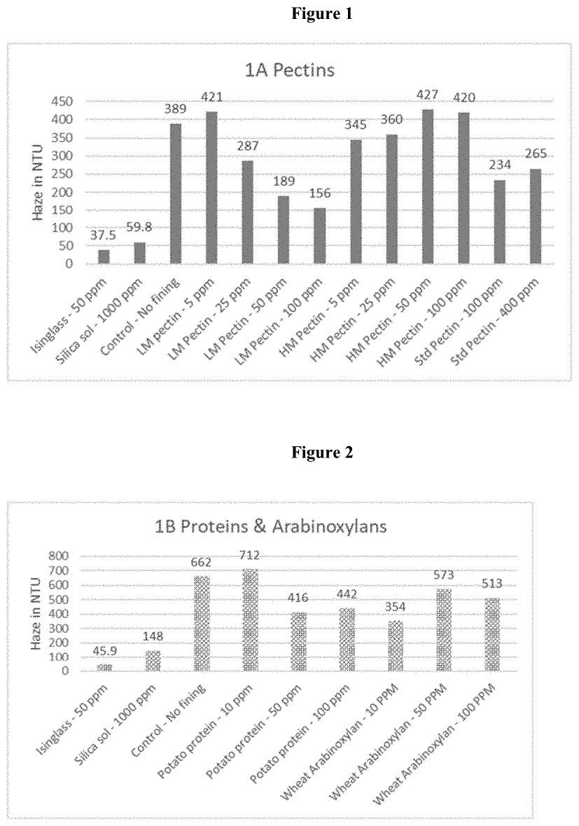

As shown in FIG. 1, the LM pectin with DE of 27%-32% and degree of amidation at 20% performed the best for fining efficiency among all pectins tested in this example.

1B. Proteins and Arabinoxylans

Beer preparation and haze measurement were carried out in a similar manner to those in Example 1A.

Finings tested: In this example, typical plant protein such as potato protein and wheat arabinoxylans were tested for fining efficiency at a dose rate of 10, 50 and 100 ppm and fining efficiency was compared with a control with no fining agent and isinglass at 50 ppm.

As shown in FIG. 2, haze results after 24 hours show that there was no improvement in beer clarity for the samples treated with both potato protein and arabinoxylans compared to the positive control isinglass and silica sol.

1C. Yeast Extracts

Beer preparation and haze measurement were carried out in a similar manner to those in Example 1A.

Finings tested: In this example, different yeast extracts rich in cell wall and mannoprotein and with different sources were added at a dose rate of 100 ppm and fining efficiency was compared with a control with no fining agent and isinglass at 50 ppm. The details of the different yeast extracts used in this example are shown in the following Table 1.

TABLE 1

| Sample No. | Source | % Protein | Description |
|---|---|---|---|
| YE1 | Saccharomyces | 70.6 | spray-dried yeast extract |
| | cerevisiae | | |
| YE2 | Saccharomyces | 76.9 | dried autolysed yeast powder |
| | cerevisiae | | produced from a selected |
| | | | strain of baker’s yeast |
| YE3 | Saccharomyces | 66.3 | dried yeast cell wall |
| | cerevisiae | | |
| YE4 | Saccharomyces | 20.0 | dried baker’s yeast cell walls |
| | cerevisiae | | rich in mannoproteins |
| YE5 | Saccharomyces | 64.0 | spray-dried extract from |
| | cerevisiae | | baker's yeast, (Saccharomyces |
| | | | cerevisiae) made from yeast |
| | | | grown specifically for cell |
| | | | nutrition purposes |
| YE6 | Saccharomyces | 54.4 | dried autolysed yeast powder |
| | cerevisiae | | produced from a selected |
| | | | strain of bakers’ yeast |

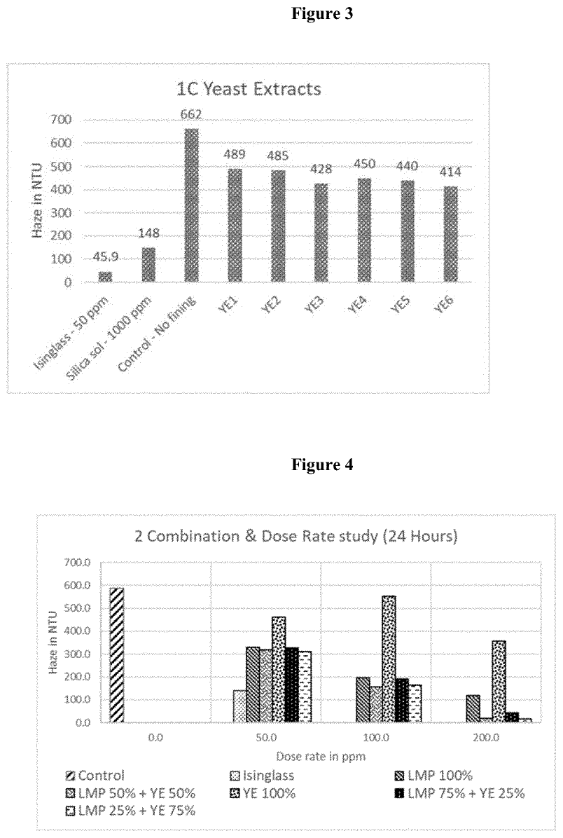

As shown in FIG. 3, haze results after 24 hours show that there was no improvement in beer clarity for samples treated with all yeast extracts on their own compared to the positive control isinglass.

### Example 2

Combination Study & Dose Rate Combination

Beer preparation and haze measurement were carried out in a similar manner to those in Example 1A.

Finings tested: In this example, different formulations as a combination of LM pectin and yeast extract where 25, 50, 75 and 100% of pectin and the rest with different yeast extracts, and a combination of each at a dose rate of 50, 100 and 200 ppm were tested. Fining efficiency was compared with a control with no fining agent and isinglass at 50 ppm as a positive control.

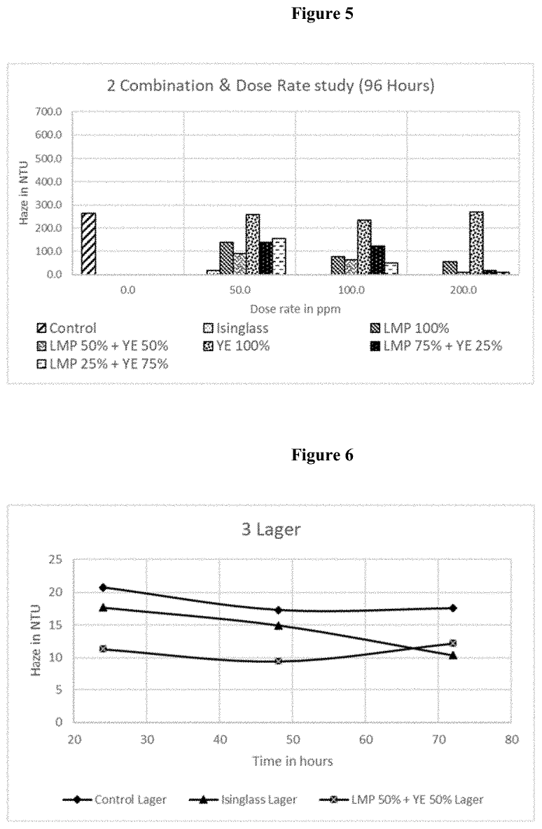

As shown in FIGS. 4 and 5, among the samples tested, a formulation with 50% of both pectin and yeast extract, and a formulation with 25% pectin and 75% yeast extract have performed the best in terms of delivering clear beer with haze reduction for 24 hours (FIGS. 4) and 96 hours (FIG. 5).

### Example 3

Different Types of Beers and Sedimentation Quality (Imhoff Cone)

Beer preparation and fining agent tested: Three different beer preparations including lager, red ale and IPA were prepared using different yeast and were tested as a base beer for fining combination of 50% low methoxy pectin and 50% yeast extract at a dose rate of 100 ppm.

Haze measurement was carried out in a similar manner as those in Example 1A.

Sedimentation quality: The beer at 4° C. was poured into sedimentation cones to the 100 ml mark, and stored at 4° C.; and sediment was measured visually every 24 hours over a 72 hour period.

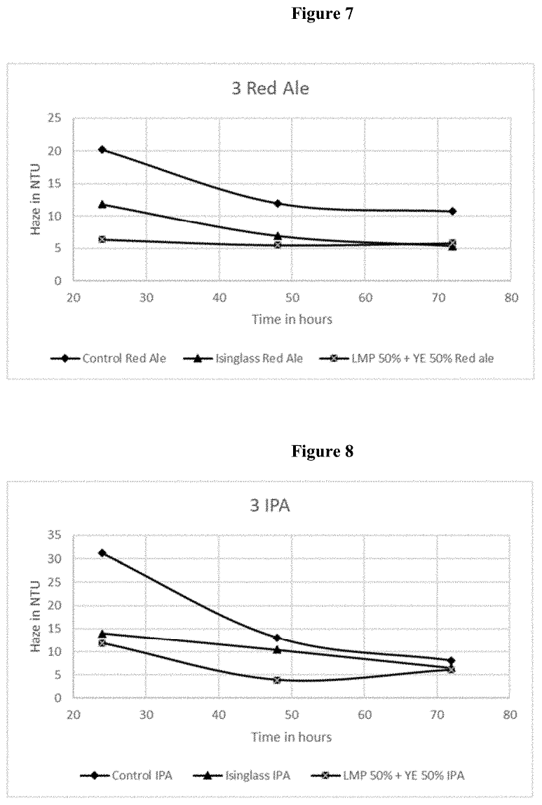

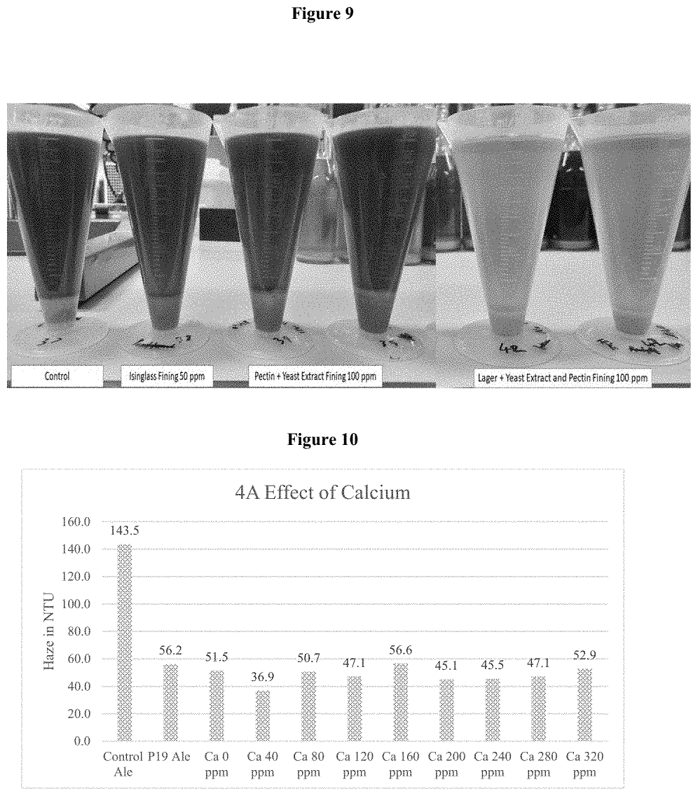

As shown in FIGS. 6-8, there was no significant difference in the fining efficiency among lager (FIG. 6), red ale (FIG. 7) and IPA (FIG. 8), demonstrating that this fining agent can be used for clarifying beers made with a wide range of recipes and yeast fermentation. As shown in FIG. 9, there was no significant difference in sediment quality and quantity when compared to isinglass for all beer types tested.

### Example 4

Effect of Calcium and pH on Beer Fining Efficiency

Beer preparation and fining agent tested: Beer preparation and haze measurements were carried out in a similar manner to those in Example 1A, except that in one preparation, the calcium levels were adjusted using 0.1 M calcium chloride solution in water to provide calcium concentrations from 40 to 320 ppm based on the preparation. In another preparation, the pH of the beer was changed from 3.2 to 5.4 using an organic acid, such as citric acid.

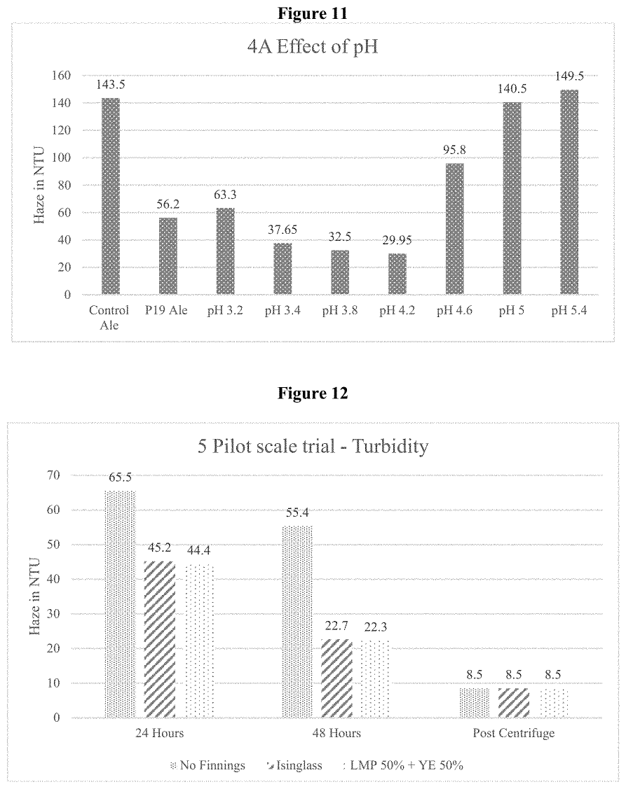

Results: Fining efficiency results suggest that there is no impact of calcium usage on fining (see FIG. 10). For fining efficiency of the disclosed agent, where the pH of the beer was maintained from 3.2 to 4.2, calcium levels added did not impact fining efficiency testing which would allow brewers to freely use fining agent irrespective of calcium levels in beer. However, from pH 4.6 and above, the haze of beer increased and reached similar levels of the control beer without a fining agent (FIG. 11). Thus, for optimum fining efficiency, the pH of beer may be maintained at pH 3.4 to 4.2.

### Example 5

Beer Fining Efficiency at Pilot Scale of 3 hL Brewery

Beer preparation and fining agent tested: A 450 L batch of wort was produced and split into three batches in 1.5 hL fermenters. The brews were monitored from brewhouse production through the end of fermentation. Post-Fermentation, the brews were combined and mixed thoroughly. 110 L of the mixed beer was sent to three 1.5 hL fermenters, chilled, and fining agent was added. The brews were closely monitored during the fining process and through final packaging.

Haze measurement was carried out in a similar manner as those in Example 1A.

Results: The pilot scale results (FIG. 12) showed that the fining efficiency of the disclosed agent having a combination of pectin and yeast extract is on par with an isinglass derived fining agent. Further, the results were consistent for 24 and 48 hours, where control sample without fining agent had the highest level of turbidity or haze.

While there have been shown and described fundamental novel features of the disclosure as applied to the preferred and exemplary embodiments thereof, it will be understood that omissions and substitutions and changes in the form and details of the disclosure may be made by those skilled in the art without departing from the spirit of the disclosure. Moreover, as is readily apparent, numerous modifications and changes may readily occur to those skilled in the art. For example, any feature(s) in one or more embodiments may be applicable and combined with one or more other embodiments. Hence, it is not desired to limit the present disclosure to the exact construction and operation shown and described and, accordingly, all suitable modification equivalents may be resorted to falling within the scope of the present disclosure as claimed. In other words, although the embodiments of the disclosure have been described with reference to the above examples, it will be understood that modifications and variations are encompassed within the spirit and scope of the disclosure. Accordingly, the invention is limited only by the following claims.

What is claimed is:

1. A method of fining a beverage, the method comprising: adding to the beverage a fining agent comprising pectin and yeast extract.

2. The method according to claim 1, wherein a total combined amount of the pectin and the yeast extract is 5-600 ppm of a total beverage volume.

3. The method according to claim 1, wherein a total combined amount of the pectin and the yeast extract is 25-500 ppm of a total beverage volume.

4. The method according to claim 1, wherein the pectin is a low-methoxy pectin with a degree of esterification (DE) of 5% to less than 50%.

5. The method according to claim 1, wherein the pectin is a low-methoxy pectin with a degree of esterification (DE) of 15%-35%.

6. The method according to claim 1, wherein the pectin is a low-methoxy pectin with a degree of esterification (DE) of 27%-32%.

7. The method according to claim 1, wherein the pectin is a low-methoxy pectin with a degree of amidation (DA) of 20%.

8. The method according to claim 1, wherein the yeast extract is cell wall material, carbohydrate profile, and/or protein rich extracts of a yeast.

9. The method according to claim 1, wherein the yeast extract is cell wall material, carbohydrate profile, and/or protein rich extracts of Saccharomyces spp.

10. The method according to claim 1, wherein the fining agent comprises 5% to 95% by weight of pectin and 5% to 95% by weight of yeast extract.

11. The method according to claim 1, wherein the fining agent comprises 10% to 90% by weight of pectin and 10% to 90% by weight of yeast extract.

12. The method according to claim 1, wherein the beverage is obtained by a process including a fermentation, and the fining agent is added after the fermentation and at a time period either before, at a beginning, or during a maturation of the beverage.

13. The method according to claim 12, wherein the pectin and the yeast extract are separately dissolved in water to provide separate aqueous solutions, and the separate aqueous solutions are added to the beverage separately.

14. The method according to claim 12, wherein the pectin and the yeast extract are a powder form, are dissolved in water to provide an aqueous solution, and the aqueous solution is added to the beverage.

15. The method according to claim 1, wherein the beverage is a fermented beverage that is alcoholic or non-alcoholic.

16. The method according to claim 15, wherein the fermented beverage is beer, wine, or cider.

17. A fining agent comprising 5% to 95% by weight of pectin and 5% to 95% by weight of yeast extract.

18. The fining agent according to claim 17, which comprises 10% to 90% by weight of pectin and 10% to 90% by weight of yeast extract,

19. The fining agent according to claim 17, wherein the pectin is a low-methoxy pectin with a degree of esterification (DE) of 5%-50%.

20. The fining agent according to claim 17, wherein the pectin is a low-methoxy pectin with a degree of esterification (DE) of 15%-35%.

21. The fining agent according to claim 17, wherein the pectin is a low-methoxy pectin with a degree of esterification (DE) of 27%-32%.

22. The fining agent according to claim 17, wherein the pectin is a low-methoxy pectin with a degree of amidation (DA) of 20%.

23. The fining agent according to claim 17, wherein the yeast extract is cell wall material, carbohydrate profile, or protein rich extracts of a yeast.

24. The fining agent according to claim 17, wherein the yeast extract is cell wall material, carbohydrate profile, or protein rich extracts of Saccharomyces spp.
